(19) United States
(12) Patent Application Publication
(10) Pub. No.: US 2006/0009344 A1
(43) Pub. Date: Jan. 12, 2006

(54) Zirconia structural body and manufacturing method of the same

(75) Inventors: Masahiro Sone, Nagoya (JP); Masashi Totokawa, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/166,187

(22) Filed: Jun. 27, 2005

(30) Foreign Application Priority Data
Jul. 6, 2004 (JP) 2004-199615

(51) Int. Cl. C04B 35/48

(52) U.S. Cl. 501/104

(57) ABSTRACT

A zirconia structural body includes a substrate having one surface on which a first electrode, a zirconia layer, and a second electrode are successively laminated. The zirconia layer is a bonded body of mixture consisting of monoclinic zirconia crystal grains and cubic zirconia crystal grains.

### CROSS-REFERENCE TO RELATED APPLICATION

This application is based upon and claims the benefit of priority from earlier Japanese Patent Application No. 2004-199615 filed on Jul. 6, 2004 so that the description of which is incorporated herein by reference.

### BACKGROUND OF THE INVENTION

The present invention relates to a zirconia structural body including a substrate having one surface on which a first electrode, a zirconia layer, and a second electrode are successively laminated, and also relates to a method for manufacturing this zirconia structural body.

The Japanese patent application laid-open No. 6-201642(1994) corresponding to U.S. Pat. No. 5,480,535 (hereinafter referred to as prior art document 1) or the Japanese patent application laid-open No. 7-55765 (1995) corresponding to U.S. Pat. No. 5,480,535 (hereinafter referred to as prior art document 2) discloses a zirconia structural body including a substrate having one surface on which a first electrode, a zirconia layer, and a second electrode are successively laminated. The zirconia structural bodies disclosed in these prior art documents 1 and 2 are air-fuel ratio sensors having a thin-film laminated structure including a zirconia layer as a solid electrolyte.

Conventionally, oxygen sensors, exhaust gas sensors, or air-fuel ratio sensors used in automotive vehicles are usually manufactured by successively laminating a plurality of sheets of zirconia or other ceramic constituent materials according to a so-called sheet laminating method. However, using this sheet laminating method is not preferable to reduce the thicknesses of various functional layers, such as zirconia layers, other solid electrolyte layers, and gas diffusion layers. The sensor obtained by the sheet laminating method will have a large thermal capacity and a long gas diffusion distance. The activation time of the sensor cannot be shortened sufficiently. And, the sensor response will be dissatisfactory.

On the other hand, according to the thin-film multilayered air-fuel ratio sensors disclosed in the above-described prior art documents 1 and 2, all of the first electrode, the solid electrolyte layer (i.e. the zirconia layer), and the second electrode are formed by spattering or by a comparable thin-film forming method. The solid electrolyte layer and other layers formed by the spattering or comparable thin-film forming method are thin 10 enough compared with those formed by the above-described sheet laminating method. The activation time of the sensor can be shortened, and the response of the sensor can be improved.

The above-described conventional spattering or thin-film forming method, although effective in improving sensor characteristics, requires high vacuum and takes a long time to form films of the sensor since this method depends on a vapor growth method. Therefore, the method disclosed in the above-described prior art document 1 or 2 is dissatisfactory in productivity. Accordingly, the manufacturing costs of the sensor will increase.

Furthermore, the zirconia layer (i.e. the solid electrolyte layer) is usually made of a zirconia (ZrO₂) containing yttria (Y₂O₃) in form of solid solution. The zirconia layer obtained by the above-described conventional spattering or comparable thin-film forming method is homogeneous in composition. Namely, the zirconia layer contains yttrium (Y), zirconium (Zr), and oxygen (O) components being uniformly diffused.

FIG. 3 is a constitution diagram of the ZrO₂—Y₂O₃ based alloy. According to the ZrO₂—Y₂O₃ based alloy, the zirconia in the composition range from 1.5 to 8 mol % in the content of Y₂O₃ causes a phase transformation between the monoclinic phase (M-phase) and the tetragonal phase (T-phase) accompanied with a 5% volumetric change at the temperature level of 500-600° C. The oxygen sensors, exhaust gas sensors, or air-fuel ratio sensors of automotive vehicles are usually placed in the temperature environment ranging from the room temperature to the high temperature of approximately 800° C. Thus, the zirconia in the above-described composition range possibly cause cracks due to the volumetric change occurring in the phase transformation. The reliability of the sensor will deteriorate. Accordingly, when the above-described conventional spattering or thin-film forming method is used to form a layer homogeneous in composition, the zirconia layer is usually a cubic (C-phase) zirconia having the composition equal to or greater than 8 mol % in the content of Y₂O₃ because it causes no phase transformation in the above temperature environment.

On the other hand, the support substrate used for forming thin films of a thin-film exhaust gas sensor is usually an alumina (Al₂O₃) having excellent thermal conductivity. The alumina has a thermal expansion coefficient of approximately 7 ppm° C.⁻¹. On the other hand, the above-described cubic zirconia layer, whose composition range is equal to or greater than 8 mol % in the content of Y₂O₃, has a thermal expansion coefficient of approximately 10.8 ppm° C.⁻¹. Therefore, when the thin-film exhaust gas sensor uses the cubic zirconia layer to prevent phase transformation, cracks will generate due to a thermal expansion coefficient difference between the alumina substrate and the cubic zirconia layer. The reliability of the sensor will deteriorate.

### SUMMARY OF THE INVENTION

In view of the above-described problems, the present invention has an object to provide a zirconia structural body excellent in reliability and also has an object to provide a manufacturing method of the same. More specifically, the present invention is applied to a zirconia structural body including a first electrode, a zirconia layer, and a second electrode which are successively laminated. The present invention has an object to provide a thin zirconia layer of the zirconia structural body. The present invention has an object to provide a zirconia structural body, when incorporated in a sensor, capable of improving the response of the sensor. The present invention has an object to provide a zirconia structural body which can be manufactured at low costs. The present invention has an object to provide a zirconia structural body which generates no cracks.

In order to accomplish the above and other related objects, the present invention provides a zirconia structural body including a substrate having one surface on which a first electrode, a zirconia layer, and a second electrode are successively laminated, wherein the zirconia layer is a bonded body of mixture consisting of monoclinic zirconia crystal grains and cubic zirconia crystal grains.

According to the zirconia structural body of the present invention, the zirconia layer is a bonded body of mixture consisting of monoclinic zirconia crystal grains and cubic zirconia crystal grains. The zirconia layer according to the present invention is not a layer homogeneous in composition. Yttrium (Y), zirconium (Zr), and oxygen (O) components are not uniformly diffused in the zirconia layer. The zirconia layer of the present invention is characterized in that monoclinic (M-phase) zirconia crystal grains and cubic (C-phase) zirconia crystal grains are independently present in the zirconia layer. According to the zirconia layer of the present invention, the monoclinic (M-phase) zirconia crystal grains contain yttria (Y₂O₃) by 1.5 mol % or less in the above-described ZrO₂—Y₂O₃ based alloy constitution diagram. Furthermore, according to the zirconia layer of the present invention, the cubic (C-phase) zirconia crystal grains contain yttria (Y₂O₃) by 8 mol % or more in the above-described ZrO₂—Y₂O₃ based alloy constitution diagram. As the zirconia layer of the present invention is a bonded body of mixed grains, an average composition of Y₂O₃ in the zirconia layer may be in the range from 1.5 to 8 mol %. However, the zirconia layer of the present invention does not cause any phase transformation in the temperature environment ranging from the room temperature to the high temperature of approximately 800° C., because respective zirconia crystal grains are stable and cause no phase transformation in this temperature environment. Accordingly, the present invention can suppress or eliminate generation of cracks which may occur in the phase transformation. The present invention can provide the zirconia structural body having excellent reliability. Furthermore, even when the substrate of the zirconia layer is alumina (Al₂O₃) having excellent thermal conductivity, the present invention can reduce a thermal expansion coefficient difference between the zirconia layer and the alumina substrate by appropriately adjusting the average composition of Y₂O₃ in the zirconia layer to be identical with or close to the thermal expansion coefficient of the alumina (i.e. approximately 7 ppm° C.⁻¹). Therefore, the present invention can suppress or eliminate generation of cracks since substantially no thermal expansion coefficient difference is present between the zirconia layer and the substrate. Thus, the zirconia structural body of the present invention can possess excellent reliability.

According to the zirconia structural body of the present invention, it is preferable that the average grain diameter of the monoclinic zirconia crystal grains and the cubic zirconia crystal grains is in the range from 5 nm to 1000 nm.

According to this arrangement, the above-described monoclinic and cubic zirconia crystal grains are independently present without causing any phase transformation in the temperature environment ranging from the room temperature to the high temperature of approximately 800° C. The thermal expansion coefficient of this zirconia layer can be a thermal expansion coefficient corresponding to the average composition of Y₂O₃ in the ZrO₂—Y₂O₃ based alloy.

Furthermore, according to the zirconia structural body of the present invention, it is preferable that an average composition of yttria contained in the zirconia layer is in the range from 4 mol % to 8 mol %.

According to this arrangement, when the substrate for forming the zirconia layer is the above-described alumina substrate having excellent thermal conductivity, it becomes possible to equalize the overall thermal expansion coefficient of the zirconia layer with the thermal expansion coefficient of the alumina substrate. Thus, this arrangement makes it possible to suppress or eliminate any cracks which may occur due to a thermal expansion coefficient difference. As a result, the zirconia structural body can possess excellent thermal conductivity and higher reliability.

Furthermore, according to the zirconia structural body of the present invention, it is preferable that the zirconia layer has a thickness in the range from 1 μm to 20 μm.

Using the zirconia layer (i.e. solid electrolyte layer) having a thickness equal to or less than 20 μm brings the effects of shortening the sensor activation time and improving the sensor response when the zirconia structural body is used as an exhaust gas sensor or the like. Furthermore, using the zirconia layer having a thickness equal to or greater than 1 μm brings the effect of enhancing the strength of the zirconia layer although it is a bonded body of mixture consisting of monoclinic zirconia crystal grains and cubic zirconia crystal grains.

Furthermore, according to the zirconia structural body of the present invention, to obtain a bonded body of mixture consisting of monoclinic zirconia crystal grains and cubic zirconia crystal grains, it is preferable to form the zirconia layer by causing an aerosol of the monoclinic zirconia crystal grains and the cubic zirconia crystal grains to collide with the substrate under a depressurized condition.

The aerosol can be formed by letting the monoclinic zirconia crystal grains and the cubic zirconia crystal grains diffuse in a gas. The above-described zirconia layer can be simply formed as a film by causing this aerosol to collide with the substrate under a depressurized condition. In short, this film-forming method utilizes impact fixation for depositing the crystal grains and accordingly the film-forming processing can be accomplished in a short time. Accordingly, it becomes possible to suppress or eliminate the generation of the above-described cracks. The zirconia structural body having higher reliability can be manufactured at low costs.

Furthermore, according to the zirconia structural body of the present invention, it is preferable that the first electrode and the second electrode are platinum layers, and the platinum layers are formed by causing an aerosol of platinum crystal grains to collide with the substrate under a depressurized condition.

The electrode made of a platinum (Pt) layer can be used even in a high-temperature environment exceeding 1000° C. This platinum layer can be simply formed by causing the aerosol of platinum crystal grains to collide with the substrate under a depressurized condition. Thus, the electrode can possess excellent heat-resisting properties. The zirconia structural body can be manufactured at low costs.

The zirconia structural body including the zirconia layer (i.e. solid electrolyte) can be used as an exhaust gas sensor or the like. In such a case, it is preferable to provide a heater on the other surface of the substrate. The heater functions as a means for increasing the temperature of the zirconia layer (i.e. solid electrolyte) up to a predetermined level. Thus, the sensor of this zirconia structural body can be stably used with high sensitivity in a temperature environment ranging from the room temperature to the high temperature of approximately 1000° C. Furthermore, according to the zirconia structural body of the present invention, it is preferable that the heater is a platinum layer, and the platinum layer is formed by causing an aerosol of platinum crystal grains to collide with the substrate under a depressurized condition. According to this arrangement, like the above-described electrode, the heater can possess excellent heat-resisting properties and the zirconia structural body can be manufactured at low costs.

Furthermore, according to the zirconia structural body of the present invention, it is preferable that the substrate is a porous substrate allowing diffusion of gas. The zirconia structural body including the zirconia layer (i.e. solid electrolyte) can be used as an exhaust gas sensor or the like. In such a case, it is possible to utilize the substrate as a diffusion layer of oxygen (O₂) gas.

Furthermore, according to the zirconia structural body of the present invention, it is preferable that the zirconia structural body is an oxygen sensor, an exhaust gas sensor, or an air-fuel ratio sensor which includes a zirconia layer of solid electrolyte.

Furthermore, in order to accomplish the above and other related objects, the present invention provides a method for manufacturing a zirconia structural body including a substrate having one surface on which a first electrode, a zirconia layer, and a second electrode are successively laminated, characterized in that the zirconia layer is formed by causing an aerosol of monoclinic zirconia crystal grains and cubic zirconia crystal grains to collide with the substrate at a velocity in a range from 300 rn/sec to 1000 m/sec under a depressurized condition.

With this manufacturing method, the zirconia layer can be formed as a bonded body of mixture consisting of monoclinic zirconia crystal grains and cubic zirconia crystal grains. The zirconia layer formed according to this manufacturing method can be bonded to the substrate with a sufficient bonding strength. The zirconia structural body formed according to this manufacturing method brings above-described effects.

According to the manufacturing method of the present invention, it is preferable that an average grain diameter of the monoclinic zirconia crystal grains and the cubic zirconia crystal grains is in the range from 100 nm to 5000 nm. Causing the aerosol containing the above-described zirconia crystal grains to collide with the substrate under a depressurized condition makes it possible to obtain a zirconia layer containing zirconia crystal grains having an average grain diameter in the range from 5 nm to 1000 nm. In this case, the monoclinic and cubic zirconia crystal grains are independently present without causing any phase transformation in the temperature environment ranging from the room temperature to the high temperature of approximately 800° C. The thermal expansion coefficient of the zirconia layer can be a thermal expansion coefficient corresponding to the average composition of Y₂O₃ in the ZrO₂—Y₂O₃ based alloy.

Furthermore, according to the manufacturing method of the present invention, it is preferable that the first electrode and the second electrode are platinum layers, and the platinum layers are formed by causing an aerosol of platinum crystal grains to collide with the substrate under a depressurized condition. Furthermore, according to the manufacturing method of the present invention, it is preferable that a platinum heater layer is provided on the other surface of the substrate, and the platinum heater layer is formed by causing an aerosol of platinum crystal grains to collide with the substrate under a depressurized condition. The zirconia structural bodies formed according to these manufacturing methods bring the above-described effects.

Furthermore, according to the manufacturing method of the present invention, it is preferable that the pressure of the depressurized condition is in a range from 1 Torr to 10 Torr. According to the above-described manufacturing method of the zirconia structural body, the obtained zirconia layer has a sufficient bonding strength even in such a depressurized condition (i.e. in low vacuum condition). In this manner, requiring no high vacuum can shorten the film-forming time compared with the conventional spattering or thin-film forming method. The manufacturing costs of the zirconia structural body can be reduced.

Furthermore, according to the manufacturing method of the present invention, it is preferable that the step of causing the crystal grains to collide with the substrate is performed under a condition that the substrate is kept at temperatures not exceeding 300° C. Even in such a low-temperature condition, the above-described zirconia layer can possess a sufficient bonding strength. Accordingly, the manufacturing costs of the zirconia structural body can be reduced.

### BRIEF DESCRIPTION OF THE DRAWINGS

The above and other objects, features and advantages of the present invention will become more apparent from the following detailed description which is to be read in conjunction with the accompanying drawings, in which:

FIG. 1A is a cross-sectional view schematically showing a zirconia structural body in accordance with a preferred embodiment of the present invention;

FIG. 1B is an enlarged cross-sectional view schematically showing the crystal structure of the zirconia layer shown in FIG. 1A;

FIG. 2A is a view showing an arrangement of a film-forming apparatus in accordance with the preferred embodiment of the present invention;

FIG. 2B is a view schematically showing the process of forming a film in accordance with the preferred embodiment of the present invention; and

FIG. 3 is a state diagram of a ZrO₂—Y₂O₃ based alloy.

### DESCRIPTION OF THE PREFERRED EMBODIMENT

A preferred embodiment of the present invention will be explained hereinafter with reference to attached drawings.

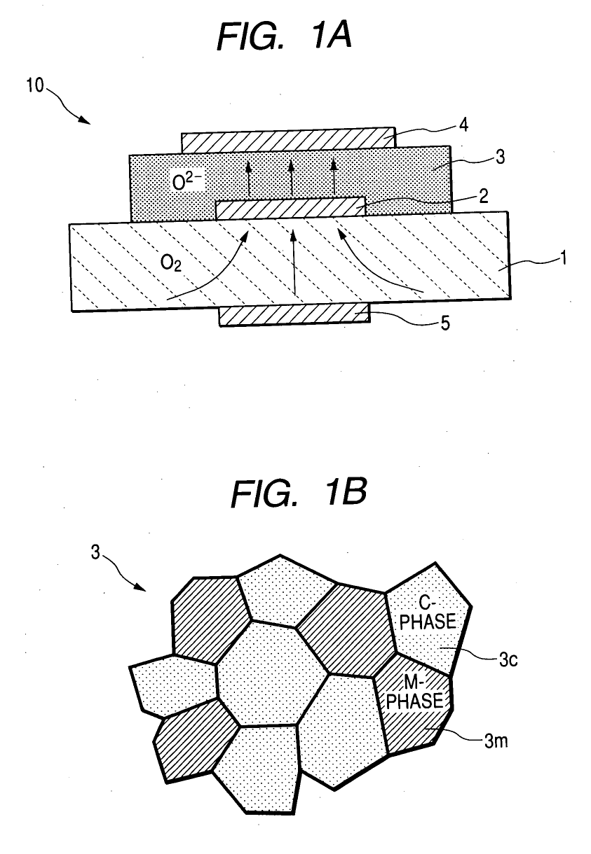

FIG. 1A is a cross-sectional view schematically showing a zirconia structural body in accordance with a preferred embodiment of the present invention.

A zirconia structural body 10 shown in FIG. 1A is an exhaust gas sensor for an automotive vehicle which includes a zirconia layer as a solid electrolyte. According to the zirconia structural body 10 shown in FIG. 1A, a first electrode 2, a zirconia layer 3, and a second electrode 4 are successively laminated on one surface of a substrate 1.

The substrate 1 shown in FIG. 1A is made of alumina (Al₂O₃) having excellent thermal conductivity. The substrate 1 is a porous substrate allowing diffusion of oxygen (O₂) gas. For example, the gas diffusibility in the substrate 1 is adjustable by controlling the porosity of an alumina material in the sintering process.

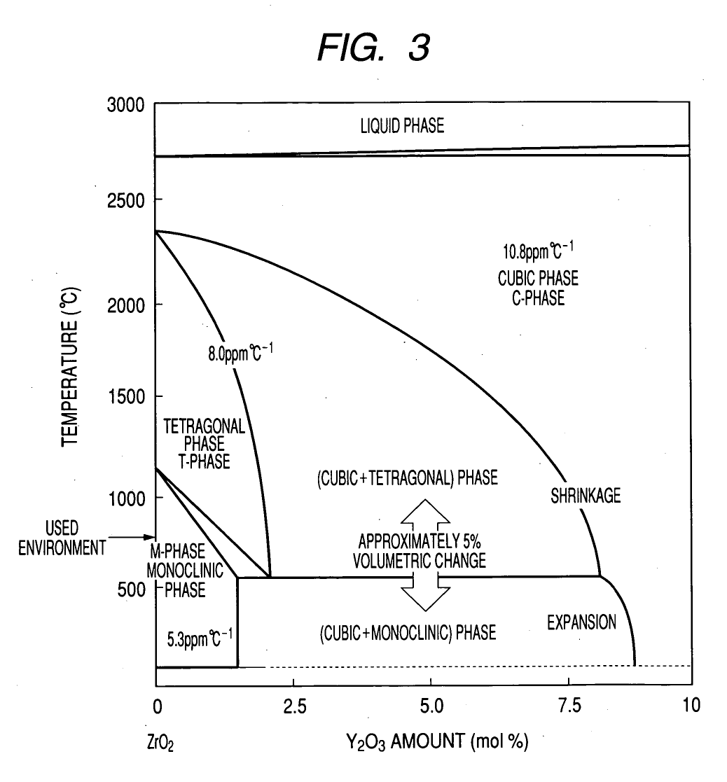

The zirconia layer 3 (i.e. solid electrolyte layer) is made of a zirconia (ZrO₂) containing yttria (Y₂O₃) in form of solid solution. To equalize the overall thermal expansion coefficient of the zirconia layer 3 with the thermal expansion coefficient (i.e. approximately 7 ppm° C.⁻¹) of the Al₂O₃ substrate 1, the average composition of Y₂O₃ in the zirconia layer 3 is set to be in the range from 4 mol % to 8 mol % in the ZrO₂—Y₂O₃ based alloy constitution diagram shown in FIG. 3. The thickness of zirconia layer 3 is set to be in the range from 1 μm to 20 μm. Using the zirconia layer 3 having a thickness equal to or less than 20 μm brings the effects of shortening the activation time of the exhaust gas sensor (i.e. zirconia structural body 10) and improving the sensor response. Furthermore, using the zirconia layer 3 having a thickness equal to or greater than 1 μm brings the effect of securing the strength of the zirconia layer 3 although it is a bonded body of mixture consisting of monoclinic zirconia crystal grains and cubic zirconia crystal grains as described later.

Both the first electrode 2 and the second electrode 4 are platinum (Pt) layers. Respective Pt layers arranging the first electrode 2 and the second electrode 4 have excellent heat-resisting properties and are accordingly durable even used in high temperature conditions exceeding 1000° C.

A heater 5 is provided on the other surface of the substrate 1. The heater 5 is made of a platinum (Pt) layer similar to those arranging the electrodes 2 and 4. The heater 5 has a function of heating the zirconia layer 3 (i.e. solid electrolyte) up to a predetermined temperature. The zirconia structural body 10, serving as an exhaust gas sensor, can operate stably with high sensitivity in the temperature environment ranging from the room temperature to the high temperature approximately 1000° C.

FIG. 1B is an enlarged cross-sectional view schematically showing the crystal structure of zirconia layer 3 shown in FIG. 1A. The zirconia layer 3 is a bonded body of mixture consisting of monoclinic (M-phase) zirconia crystal grains 3m and cubic (C-phase) zirconia crystal grains 3c in a mixed condition as shown in FIG. 1B. More specifically, the monoclinic (M-phase) zirconia crystal grains 3m contain Y₂O₃ by 1.5 mol % or less according to the ZrO₂—Y₂O₃ based alloy constitution diagram shown in FIG. 3. On the other hand, the cubic (C-phase) zirconia crystal grains 3c contain Y₂O₃ by 8 mol % or more according to the ZrO₂—Y₂O₃ based alloy constitution diagram shown in FIG. 3. The average grain diameter of monoclinic zirconia crystal grains 3m and cubic zirconia crystal grains 3c is in the range from 5 nm to 1000 nm. The grain diameter of crystal grains 3m and 3c arranging the zirconia layer 3 is sufficiently smaller than the layer thickness. Therefore, the overall thermal expansion coefficient of the zirconia layer 3 is a thermal expansion coefficient corresponding to an average composition of Y₂O₃ in the ZrO₂—Y₂O₃ based alloy, which is obtainable as a weighted average of the thermal expansion coefficient 5.3 ppm° C.⁻¹ of the monoclinic phase (M-phase) and the thermal expansion coefficient 10.8 ppm° C.⁻¹ of the cubic phase (C-phase). Furthermore, according to the zirconia layer 3 of this embodiment, when the zirconia structural body 10 is used as an exhaust gas sensor as later described, both the monoclinic zirconia crystal grains 3m and the cubic zirconia crystal grains 3c are independently present in the temperature environment ranging from the room temperature to the high temperature of approximately 800° C. without causing any phase transformation.

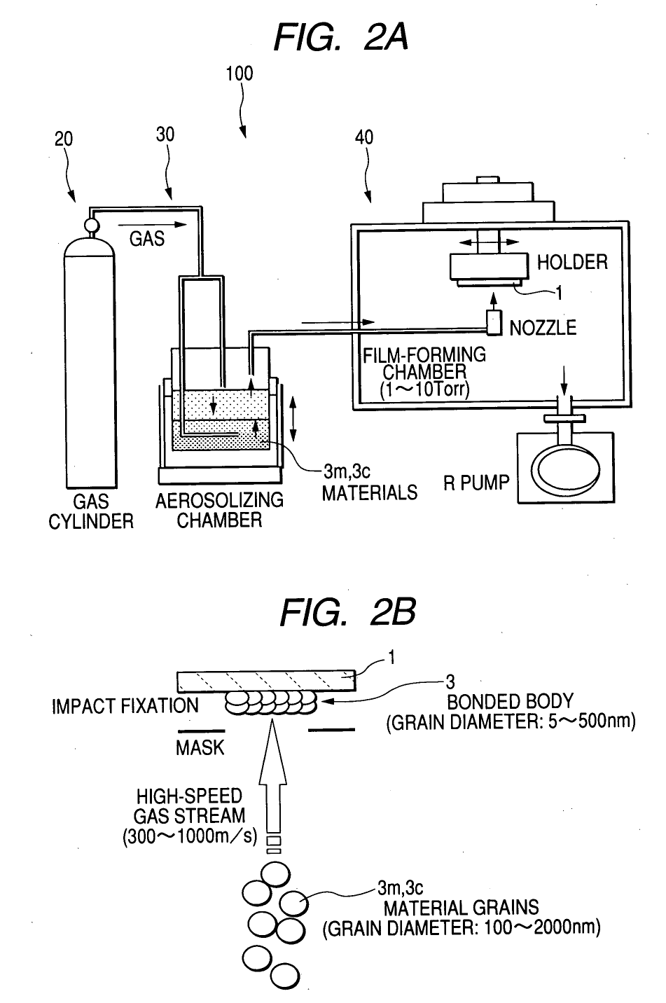

Hereinafter, a method for forming the zirconia layer 3 of this embodiment will be explained with reference to FIGS. 2A and 2B. FIG. 2A is a view showing an arrangement of a film-forming apparatus used in this embodiment. FIG. 2B is a view schematically showing the process of forming a film.

A film-forming apparatus 100 shown in FIG. 2A is characterized by using an aerosol containing ceramic fine grains diffused in a gas. More specifically, the film-forming apparatus 100 shown in FIG. 2A consists of a gas cylinder 20 storing a gas of the aerosol, an aerosolizing chamber 30 in which the materials are aerosolized with the gas, and a film-forming chamber 40.

The film-forming apparatus 100 shown in FIG. 2A stores the materials (i.e. monoclinic zirconia crystal grains 3m and cubic zirconia crystal grains 3c) in the aerosolizing chamber 30 and introduces the gas from the gas cylinder 20 into the aerosolizing chamber 30. The aerosol is formed in the aerosolizing chamber 30. The aerosol formed in the aerosolizing chamber 30 consists of monoclinic zirconia crystal grains 3m and cubic zirconia crystal grains 3c which have an average grain diameter in the range from 100 nm to 5000 nm. The aerosol formed in the aerosolizing chamber 30 is then supplied to a nozzle of film-forming chamber 40.

Next, the aerosol is sprayed out of the nozzle toward the substrate 1 fixed on a holder, under a condition that the film-forming chamber 40 is kept in a depressurized condition in the pressure range from 1 Torr to 10 Torr. A rotary (R) pump is connected to the film-forming chamber 40 to bring the inside space of the film-forming chamber 40 into such a depressurized condition.

As shown in FIG. 2B, controlling the velocity of a gas stream sprayed out of the nozzle makes it possible to cause the monoclinic and cubic zirconia crystal grains 3m and 3c to collide with the substrate 1 at the higher velocity in the range from 300 m/sec to 1000 m/sec. This collision releases a local energy and induces a mechanochemical reaction. As a result, the zirconia layer 3 having a sufficient bonding strength is formed on the surface of the substrate 1. In the sintering operation of zirconia or ordinary ceramic materials, the zirconia grains must be heated up to a temperature level equivalent to the melting point. However, the above-described thin-film forming method utilizes the collision energy and accordingly no high-temperature sintering operation is required. In this respect, the above-described thin-film forming method is excellent in productivity. Furthermore, even in a depressurized condition (i.e. in a low vacuum condition from 1 Torr to 10 Torr), it is possible to obtain the zirconia layer 3 excellent in bonding strength. As no high vacuum is required, the film-forming time can be shortened compared with the conventional spattering or thin-film forming method. The zirconia crystal grains 3m and 3c, contained in the aerosol, originally have an average grain diameter in the range from 100 nm to 5000 nm. When subjected to the collision, these zirconia crystal grains 3m and 3c are crushed into smaller grains having an average grain diameter in the range from 5 nm to 1000 nm. Thus, the zirconia layer 3 is formed as a bonded body of mixture consisting of zirconia crystal grains 3m and 3c, as shown in shown in FIG. 1B.

The zirconia layer 3 shown in FIGS. 1A and 1B being formed as described above is not a layer homogeneous in composition. Accordingly, yttrium (Y), zirconium (Zr), and oxygen (O) components are not uniformly diffused in the zirconia layer 3, unlike the zirconia layer obtained according to the conventional spattering or thin-film forming method. In other words, the zirconia layer 3 shown in FIG. 1B contains monoclinic (M-phase) zirconia crystal grains 3m and cubic (C-phase) zirconia crystal grains 3c which are independently present. Accordingly, even when the average composition of Y₂O₃ in the zirconia layer 3 is in the range of 1.5 to 8 mol %, respective zirconia crystal grains 3m and 3c do not cause any phase transformation in the temperature environment ranging from the room temperature to the high temperature of approximately 800° C. Therefore, the zirconia layer 3 of this embodiment is free from the phase transformation between the monoclinic phase (M-phase) and the tetragonal phase (T-phase) accompanied with a 5% volumetric change at the temperature level of 500 to 600° C. shown in FIG. 3. Thus, the zirconia structural body according to this embodiment can suppress or eliminate the generation of cracks which may occur due to the phase transformation. The zirconia structural body according to this embodiment has excellent reliability.

Furthermore, this embodiment uses the substrate 1 made of Al₂O₃ for forming the zirconia layer 3 as it has excellent thermal conductivity. However, the average composition of Y₂O₃ in the zirconia layer 3 can be appropriately adjusted to be in the range from 1.5 to 8 mol %, preferably in the range from 4 mol % to 8 mol %, so as to reduce a difference between the thermal expansion coefficient of the zirconia layer 3 and the thermal expansion coefficient of Al₂O₃ (i.e. approximately 7 ppm ° C.⁻¹). Therefore, it becomes possible to suppress or eliminate the cracks which may occur due to the thermal expansion coefficient difference between the substrate 1 and the zirconia layer 3. The zirconia structural body of this embodiment has excellent reliability.

Furthermore, the method for forming the zirconia layer 3 using the aerosol shown in FIGS. 2A and 2B is a simple film-forming method because the crystal grains are easily deposited by utilizing the impact fixation as described above. Furthermore, this method does not require high vacuum. The film-forming time can be shortened compared with the conventional spattering or thin-film forming method. The zirconia structural body 10 shown in FIG. 1A can be manufactured at low costs. The above-described film-forming method using the aerosol is applicable to form the first electrode 2, the second electrode 4, and the heater 5 shown in FIG. 1A. In this case, the first electrode 2, the second electrode 4, and the heater 5 can be formed by causing the aerosol of platinum (Pt) crystal grains to collide with the substrate 1 under a depressurized condition as explained with reference to FIGS. 2A and 2B. In this manner, employing the film-forming method using the above-described aerosol makes it possible to form the first electrode 2, the second electrode 4, and the heater 5 in addition to the zirconia layer 3. The zirconia structural body 10 shown in FIG. 1A can be manufactured at low costs.

Although the zirconia structural body explained in the above-described embodiment of the present invention is an exhaust gas sensor used in an automotive vehicle, it is also preferable to use the zirconia structural body of the present invention as an oxygen sensor or an air-fuel ratio sensor. Furthermore, the zirconia structural body of the present invention can have a sufficiently thin zirconia layer and accordingly can improve the sensor response. Thus, the zirconia structural body of the present invention can be used for any sensor including the zirconia layer (i.e. solid electrolyte). Moreover, the zirconia structural body and its manufacturing method of the present invention can be used for any other purposes. The zirconia structural body according to the present invention can suppress or eliminate any cracks and can possess higher reliability. According to the manufacturing method of the present invention, the zirconia structural body can be manufactured at low costs.

What is claimed is:

1. A zirconia structural body comprising a substrate having one surface on which a first electrode, a zirconia layer, and a second electrode are successively laminated one on another, wherein
said zirconia layer is composed of a bonded body of mixture consisting of monoclinic zirconia crystal grains and cubic zirconia crystal grains.

2. The zirconia structural body in accordance with claim 1, wherein an average grain diameter of said monoclinic zirconia crystal grains and said cubic zirconia crystal grains is in the range from 5 nm to 1000 nm.

3. The zirconia structural body in accordance with claim 1, wherein an average composition of yttria contained in said zirconia layer is in the range from 4 mol % to 8 mol %.

4. The zirconia structural body in accordance with claim 1, wherein said zirconia layer has a thickness in the range from 1 μm to 20 μm.

5. The zirconia structural body in accordance with claim 1, wherein said zirconia layer is formed by causing an aerosol of said monoclinic zirconia crystal grains and said cubic zirconia crystal grains to collide with said substrate under a depressurized condition.

6. The zirconia structural body in accordance with claim 1, wherein
said first electrode and said second electrode are composed of platinum layers, respectively, and
said platinum layers are formed by causing an aerosol of platinum crystal grains to collide with said substrate under a depressurized condition.

7. The zirconia structural body in accordance with claim 1, wherein a heater is provided on the other surface of said substrate.

8. The zirconia structural body in accordance with claim 7, wherein
said heater is formed by a platinum layer, and
said platinum layer is formed by causing an aerosol of platinum crystal grains to collide with said substrate under a depressurized condition.

9. The zirconia structural body in accordance with claim 1, wherein said substrate is a porous substrate allowing diffusion of gas.

10. The zirconia structural body in accordance with claim 1, wherein said zirconia structural body is formed by an oxygen sensor.

11. The zirconia structural body in accordance with claim 1, wherein said zirconia structural body is formed by an exhaust gas sensor.

12. The zirconia structural body in accordance with claim 1, wherein said zirconia structural body is formed by an air-fuel ratio sensor.

13. A method for manufacturing a zirconia structural body including a substrate having one surface on which a first electrode, a zirconia layer, and a second electrode are successively laminated one on another, comprising a step of forming said zirconia layer by causing an aerosol of monoclinic zirconia crystal grains and cubic zirconia crystal grains to collide with said substrate at a velocity in the range from 300 m/sec to 1000 m/sec under a depressurized condition.

14. The method for manufacturing a zirconia structural body in accordance with claim 13, wherein an average grain diameter of said monoclinic zirconia crystal grains and said cubic zirconia crystal grains is in the range from 100 nm to 5000 nm.

15. The method for manufacturing a zirconia structural body in accordance with claim 13, wherein
said first electrode and said second electrode are composed of platinum layers, respectively, and
said platinum layers are formed by causing an aerosol of platinum crystal grains to collide with said substrate under a depressurized condition.

16. The method for manufacturing a zirconia structural body in accordance with claim 13, wherein
a platinum heater layer is provided on the other surface of said substrate, and
said platinum heater layer is formed by causing an aerosol of platinum crystal grains to collide with said substrate under a depressurized condition.

17. The method for manufacturing a zirconia structural body in accordance with claim 13, wherein the pressure of said depressurized condition is in the range from 1 Torr to 10 Torr.

18. The method for manufacturing a zirconia structural body in accordance with claim 13, wherein the step of causing said crystal grains to collide with said substrate is performed under a condition that said substrate is kept at temperatures not exceeding 300° C.
